(19) United States
(12) Patent Application Publication
(10) Pub. No.: US 2020/0400007 A1
(43) Pub. Date: Dec. 24, 2020

(54) TOP DRIVE SYSTEM DYNAMICS HEALTH CHECK TOOL

(71) Applicant: Schlumberger Technology Corporation, Suger Land, TX (US)

(72) Inventors: Jian WU, Houston, TX (US); Nathaniel WICKS, Somerville, MA (US)

(21) Appl. No.: 16/975,219

(22) PCT Filed: Feb. 25, 2019
(86) PCT No.: PCT/US2019/019332

§ 371 Date: Aug. 24, 2020

Related U.S. Application Data
(60) Provisional application No. 62/634,497, filed on Feb. 23, 2018.

(51) Int. Cl. E21B 44/04; E21B 49/00; E21B 3/02; G05B 17/02

(52) U.S. Cl. CPC E21B 44/04; G05B 17/02; E21B 3/022; E21B 49/003

(57) ABSTRACT

A model of a control loop for a variable-frequency drive (VFD) and a top drive (TD) is generated. The VFD and the TD are part of a VFD-TD system of a well drilling system. Expected magnitude and phase frequency responses are determined utilizing the model. The VFD and TD are tested by injecting a sequence of sine wave signals with different, predetermined frequencies from an external controller to the VFD as TD speed setpoint inputs on top of a constant base speed, and logging the test data. Magnitude and phase delay for the different frequency sine inputs to the VFD-TD loop are determined based on the logged data. Health of the VFD-TD system is assessed by comparing the determined magnitude and phase responses with the expected magnitude and phase responses.

### CROSS-REFERENCE TO RELATED APPLICATIONS

This application claims priority to and the benefit of U.S. Provisional Application No. 62/634,497, titled “Top Drive Health,” filed Feb. 23, 2018, the entire disclosure of which is hereby incorporated herein by reference.

### BACKGROUND OF THE DISCLOSURE

Wells are generally drilled into the ground or ocean bed to recover natural deposits of oil, gas, and other materials that are trapped in subterranean formations. The wells are drilled into the subterranean formations using a drill bit attached to a lower end of a drill string. A top drive (TD) that moves vertically along a derrick at the wellsite surface imparts rotary motion to the drill string and, thus, the drill bit to form the well.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a method that includes determining expected magnitude and phase frequency responses of a top drive (TD) driven by a variable frequency drive (VFD). The VFD and the TD are part of a VFD-TD system of a well drilling system. Determining the expected magnitude and phase frequency responses utilizes a model of a control loop for the VFD and the TD. The method also includes generating test data by injecting a sequence of sine wave signals with different, predetermined frequencies to the VFD as TD speed setpoint inputs on top of a constant base speed. Magnitude and phase delay for the different frequency sine inputs to the VFD-TD control loop are determined based on the test data. Health of the VFD-TD system is assessed by comparing the determined magnitude and phase responses with the expected magnitude and phase responses.

The present disclosure also introduces a processing system including a processor having a local memory, a main memory in communication with the processor, an input device in communication with the processor via an interface circuit, and an output device in communication with the processor via the interface circuit. The processor is operable to execute coded instructions stored in the memory device and/or the local memory to communicate with a VFD via the interface circuit. The VFD is operable to drive a TD, and the VFD and the TD are part of a VFD-TD system of a well drilling system. The processor is also operable to execute coded instructions stored in the memory device and/or the local memory to, in response to human-initiation via the input device, automatically: determine expected magnitude and phase frequency responses utilizing a model of a control loop for the VFD and the TD; generate test data by injecting a sequence of sine wave signals with different, predetermined frequencies to the VFD as TD speed setpoint inputs on top of a constant base speed; determine magnitude and phase delay for the different frequency sine inputs to the VFD-TD control loop based on the test data; and output to the output device an indication of health of the VFD-TD system. The health indication is based on a comparison of the determined magnitude and phase responses with the expected magnitude and phase responses.

The present disclosure also introduces method that includes entering a single input to an input device of a processing system, thereby commencing operation of a processor of the processing system to execute coded instructions stored in memory of the processing system to: determine expected magnitude and phase frequency responses of a TD driven by a VFD, the VFD and the TD being part of a VFD-TD system of a well drilling system, and the expected magnitude and phase frequency responses being determined utilizing a model of a control loop for the VFD and the TD; generate test data by injecting a sequence of sine wave signals with different, predetermined frequencies to the VFD as TD speed setpoint inputs on top of a constant base speed; determine magnitude and phase delay for the different frequency sine inputs to the VFD-TD control loop based on the test data; determine an indication of health of the VFD-TD system by comparing the determined and expected magnitude and phase responses; and output the health indication via an output device of the processing system.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a flow-chart diagram of at least a portion of an example implementation of a method according to one or more aspects of the present disclosure.

FIG. 3 is a schematic view of at least a portion of an example implementation of a control loop according to one or more aspects of the present disclosure.

FIG. 4 is a schematic view of at least a portion of an example implementation of apparatus according to one or more aspects of the present disclosure.

FIG. 5 is a graph pertaining to one or more aspects of the present disclosure.

FIG. 6 is a graph pertaining to one or more aspects of the present disclosure.

FIG. 7 is a graph pertaining to one or more aspects of the present disclosure.

FIG. 8 is a graph pertaining to one or more aspects of the present disclosure.

FIG. 9 is a graph pertaining to one or more aspects of the present disclosure.

FIG. 10 is a graph pertaining to one or more aspects of the present disclosure.

FIG. 11 is a graph pertaining to one or more aspects of the present disclosure.

FIG. 12 is a schematic view of at least a portion of an example implementation of apparatus according to one or more aspects of the present disclosure.

### DETAILED DESCRIPTION

It is to be understood that the following disclosure describes many example implementations for different aspects introduced herein. Specific examples of components and arrangements are described below to simplify the present disclosure. These are merely examples, and are not intended to be limiting. In addition, the present disclosure may repeat reference numerals and/or letters in the various examples. This repetition is for simplicity and clarity, and does not in itself dictate a relationship between the various implementations described herein.

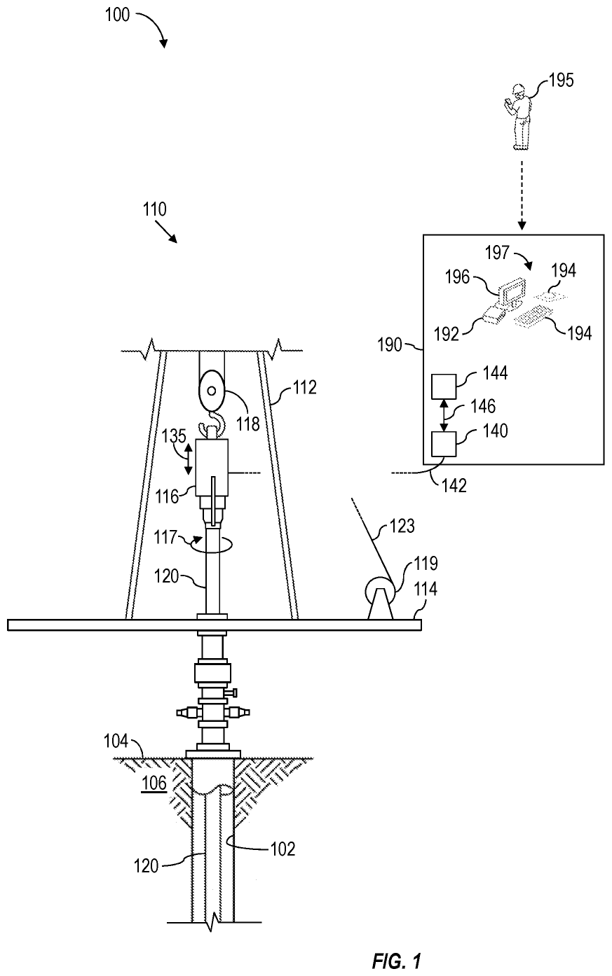

FIG. 1 is a schematic view of at least a portion of an example implementation of a well construction system 100 according to one or more aspects of the present disclosure. The well construction system 100 represents an example environment in and/or for which one or more aspects described below may be implemented. Although the well construction system 100 is depicted as an onshore implementation, the aspects described below are also applicable to offshore and inshore implementations.

The well construction system 100 is depicted in relation to a wellbore 102 formed by rotary drilling from a wellsite surface 104 and extending into a subterranean formation 106. The well construction system 100 includes surface equipment 110 located at the wellsite surface 104 and a drill string 120 suspended within the wellbore 102. The surface equipment 110 may include a mast, a derrick, and/or another wellsite structure 112 disposed over a rig floor 114. The drill string 120 may be suspended within the wellbore 102 from the wellsite structure 112.

A drill bit (not shown) is coupled to the downhole end of the drill string 120. Rotation of the drill bit and the weight of the drill string 120 collectively operate to form the wellbore 102. The wellsite structure 112 supports a TD 116 operable to connect (perhaps indirectly) with an uphole end of the drill string 120, and to impart rotary motion 117 to the drill string 120 and the drill bit. The TD 116 and the connected drill string 120 may be suspended from the wellsite structure 112 via hoisting equipment, which may include a traveling block 118, a crown block (not shown), and a drawworks 119 storing a support cable or line 123. The crown block may be connected to or otherwise supported by the wellsite structure 112, and the traveling block 118 may be coupled with the TD 116, such as via a hook. The drawworks 119 may be mounted on or otherwise supported by the rig floor 114. The crown block and traveling block 118 comprise pulleys or sheaves around which the support line 123 is reeved to operatively connect the crown block, the traveling block 118, and the drawworks 119 (and perhaps an anchor). The drawworks 119 may thus selectively impart tension to the support line 123 to lift and lower the TD 116, as indicated by arrows 135.

The surface equipment 110 of the well construction system 100 may also comprise a control center 190 (e.g., a cabin, a trailer, a facility, etc.) from which various portions of the well construction system 100 may be monitored and controlled. The control center 190 may be located on the rig floor 114 or another location of the well construction system 100, such as the wellsite surface 104. The control center 190 may contain or comprise a processing device 192 (e.g., a controller, a control system, a computer, etc.) operable to provide control of one or more portions of the well construction system 100 and/or operable to monitor operations of one or more portions of the well construction system 100. For example, the processing device 192 may be communicatively connected with the various surface and downhole equipment described herein, and may be operable to receive signals from and transmit signals to such equipment to perform various operations described herein. The processing device 192 may store executable programs, instructions, and/or operational parameters or set-points, including for implementing one or more aspects of the operations described herein. The processing device 192 may be communicatively connected with a human operator control workstation 197 from which various wellsite equipment or portions of the well construction system 100 may be monitored and controlled. The operator workstation 197 may be operable for entering or otherwise communicating commands to the processing device 192 by a human wellsite operator 195, and for displaying or otherwise communicating information from the processing device 192 to the wellsite operator 195. The operator workstation 197 may comprise a plurality of human-machine interface (HMI) devices, including one or more input devices 194 (e.g., a keyboard, a mouse, a joystick, a touchpad, etc.) and one or more output devices 196 (e.g., a video monitor, a printer, audio speakers, etc.). The control center 190 may contain or comprise the operator workstation 197. Communication between the control center 190, the processing device 192, the input and output devices 194, 196 of the operator workstation 197, and the various wellsite equipment may be via wired and/or wireless communication means. However, for clarity and ease of understanding, such communication means are not depicted, and a person having ordinary skill in the art will appreciate that such communication means are within the scope of the present disclosure.

Well construction systems within the scope of the present disclosure may include more or fewer components than as described above and depicted in FIG. 1. Additionally, various components and/or subsystems of the well construction system 100 shown in FIG. 1 may include more or fewer components than as described above and depicted in FIG. 1. For example, various engines, motors, hydraulics, actuators, valves, and/or other components not explicitly described herein may be included in the well construction system 100, and are within the scope of the present disclosure.

The TD 116 is continuously controlled and powered by a variable frequency drive (VFD) 140 via one or more cables 142. In the example illustrated in FIG. 1, the VFD 140 is depicted as being part of the control center 190. However, in other implementations within the scope of the present disclosure, the VFD 140 may be located elsewhere within the well construction system 100. The VFD 140 calculates and reports the speed and torque values to an external PLC, a computer equipped with control logic, and/or another controller 144. The controller 144 may be, or be implemented by, the processing device 192 and/or another processing device. The controller 144 determines the speed and/or torque setpoints to be used for an operation, and sends these setpoints to the VFD 140. Communication 146 between the VFD 140 and the controller 144 may be via Profibus, Profinet, Ethernet, and/or other communication protocols.

The TD 116 may use two or more alternating current (AC) motors together to provide the rotational torque that rotates the drill string 120. For example, the single VFD 140 may control and power (“drive”) the multiple motors. Alternatively, multiple VFDs 140 may each drive a corresponding motor, such as to provide redundancy in critical applications (e.g., for drilling rigs in remote areas). In such implementations, a master-slave scheme is applied for load/torque sharing, wherein just one of the VFDs 140 is a “master” drive that provides control signals to the other “slave” drives. The slave drives, also called “followers,” receive the torque setpoint and other control signals and follow/execute them on their corresponding motors. In such implementations, however, there is a time delay for the control signals sent from the master drive to reach the slave drives, which doesn't occur in implementations in which a single VFD drives multiple motors. The delay time is dependent on the communication devices and protocol utilized. The two control topologies described above can be modeled similarly, as described below, except for addressing the communication delay time for the master-slave topology.

Nominal behavior of the TD control system may be modeled as a VFD-TD control loop, comprising the VFD 140 and a large mass inertia representing the TD 116 (without the drill string attached). The model may be utilized to ensure that the TD system works properly and as expected, so that advanced control functions can function properly. The model may also account for communication delays in the TD control system, because such delays can be a crucial factor to whether control functions are successful.

The present disclosure introduces a systematic tool for checking TD dynamic health and determining communication delay of the system. The tool may be used before deployment of advanced control functions (such as a stick-slip mitigation technique), as part of regular health-checks, and/or as part of troubleshooting/diagnostics procedure.

Existing TD installations in the industry include pre-run testing on the TD control system to demonstrate performance. However, whereas existing testing utilizes continuously changing sine sweep signals as input signals, the present disclosure introduces utilizing regular sine signals at a user-specified, finite number of frequencies. Also, existing testing uses input and output data to establish an estimated continuous model to represent the measured data, whereas the present disclosure introduces using the data directly to determine the amplitude and phase delay responses at the given frequency points. Existing testing also uses torque responses to determine “pass/fail” status, whereas the present disclosure introduces using speed responses to decide pass/fail of the dynamic health checking. Existing testing also determines pass/fail based on the entire frequency range of interest, and determines whether the measured response curve is entirely within the upper/lower bounds of expected values, which can be difficult. The present disclosure introduces determining whether the system is healthy enough based on finite data points, utilizing configurable pass/fail criteria that is simple and clear. The present disclosure also introduces measuring and/or estimating the communication transport delay between the external controller and the TD system, which can be a crucial system parameter when deploying advanced control functions to the TD system.

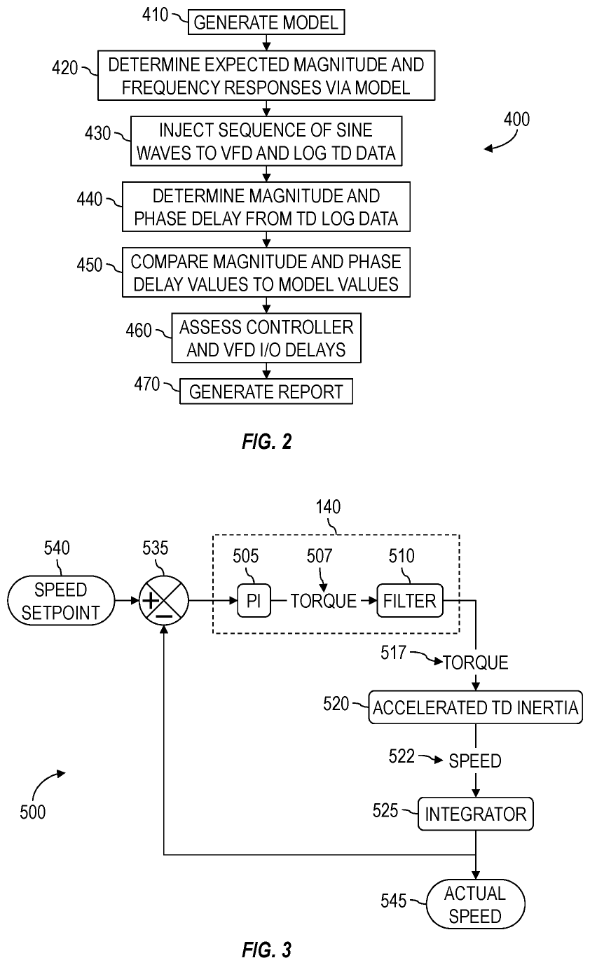

FIG. 2 is a flow-chart diagram of at least a portion of an example implementation of a method (400) according to one or more aspects of the present disclosure. At least a portion of the method (400) may be performed by and/or otherwise in conjunction with one or more instances of one or more implementations of the apparatus described above and shown in FIG. 1. At least a portion of the method (400) may also (or instead) be performed by and/or otherwise in conjunction with one or more instances of one or more implementations of the processing system 600 shown in FIG. 12 and described below.

The method (400) includes generating (410) a reference VFD-TD fast loop model having parameters involving control gains of an automatic speed regulator (ASR) associated with the VFD-TD combination, a low-pass filter(s) delay time constant, and a measured TD inertia. These parameters are input through a graphical user interface (GUI), such as may be part of an HMI described herein. The expected magnitude and phase frequency response can be then determined (420) utilizing the model.

For example, FIG. 3 is a block diagram of an example implementation of a VFD-TD system 500 comprising the proportional-integral (PI) controller 505 and filter 510 of the VFD 140, the TD inertia 520, and an integrator 525. A comparator 535 compares the speed setpoint 540 with the output of the integrator 525, which is also the actual speed 545. The PI controller 505 generates a torque signal 507, which is smoothed by the filter 510. The smoothed torque signal 517 results in accelerating the TD inertia 520, and subsequently the TD speed 522 is accounted for by the integrator 525.

Corresponding transfer functions may be as set forth below in Functions (1)-(4)

$$\begin{matrix}PI controller \text{:} {K}_{p} + \frac{{K}_{i}}{s} & ( 1 ) \\ Filter \text{:} \frac{1}{{T}_{f} s + 1} & ( 2 ) \\ TD inertia \text{:} J & ( 3 ) \\ Integrator \text{:} \frac{1}{s} & ( 4 )\end{matrix}$$

where: Kₚ is proportional gain;
Kᵢ is integral gain;
s is the Laplace transform variable; and
T_{f} is a delay time constant, derived from time constant(s) of the digital/analog low-pass filter(s) in the loop, including where the control loop includes more than one low-pass filter. For a master-slave system, T_{f}=T_{f1}+T_{f2}, where T_{f1} is the time delay caused by the low-pass filter(s), and T_{f2} is half of the communication delay between the master and slave drives, which is either known or can be estimated using the logged data.

The corresponding closed loop transfer function may then be as set forth below in Equation (5).

$$\frac{SpeedPv}{SpeedSp} = \frac{{K}_{p} s + {K}_{i}}{{T}_{f} J {s}^{3} J {s}^{2} + {K}_{p} s + {K}_{i}} \qquad ( 5 )$$

where: SpeedPv is the speed feedback (i.e., actual speed); and
SpeedSp is the speed setpoint.

In Equation (5), s may be replaced by jω, where j=−\sqrt{1} and ω is angular frequency, such that the magnitude and phase frequency response may be determined as set forth below in Equations (6) and (7).

$$\begin{matrix}Mag = 10 {log}_{10} [ {( {K}_{p} ω )}^{2} + {( {K}_{i} )}^{2} ] - {log}_{10} [ {( {K}_{i} - j {ω}^{2} )}^{2} + {( {K}_{p} ω - {T}_{f} J {ω}^{3} )}^{2} ] & ( 6 ) \\ Phase = {tan}^{- 1} \frac{{K}_{p} ω}{{K}_{i}} - {tan}^{- 1} \frac{{K}_{p} ω - {T}_{f} J {ω}^{3}}{{K}_{i} - J {ω}^{2}} & ( 7 )\end{matrix}$$

The units of magnitude and phase in Equations (6) and (7) are in dB and radians/degree, respectively. However, the units can be converted as appropriate to the implementation.

Returning to FIG. 2, the method (400) also includes injecting (430) a sequence of sine wave signals with different, predetermined frequencies from the external controller (e.g., 144 or 192 in FIG. 1) to the VFD as the TD speed setpoint inputs on top of a constant base speed. The time period of the signal at each frequency is the same, and the amplitude is constantly ranging from about five revolutions per minute (rpm) to about twenty rpm at the TD. The magnitude and frequency of the input sine waves are determined such that the acceleration limit of the TD system is not reached. The VFD can behave differently when running at high speeds (e.g., higher than rated speed) relative to when running at low speeds (e.g., lower than rated speed). Therefore, the designed tests may be at both high and low speeds.

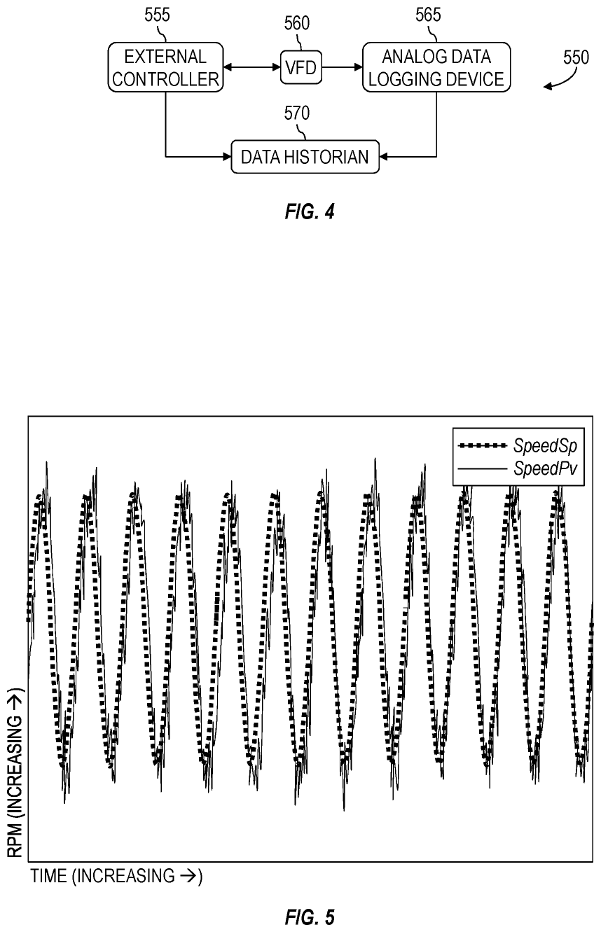

FIG. 4 is a block diagram of an example implementation of a system 550 for logging the test data. The data set may log the setpoint sent from the external controller 555, the setpoint received back at the external controller 555, and the setpoint and feedback of the speed controller in the VFD 560. The external controller 555 and the VFD 560 depicted in FIG. 4 may be the controller 144 and VFD 140 shown in FIG. 1. The VFD speed controller setpoints and feedback may be logged utilizing an analog data logging device 565, such as the analog output cards of the VFD 560. The analog data logging device 565 (and/or another component of the logging system 550) may convert the analog signals to digital signals (e.g., utilizing a PLC analog input card) for digital transmission to a data historian 570. As shown in FIG. 4, the analog data logging device 565 can be separate from the external controller 555. However, the analog data logging device 565 can be a part of the external controller 555, such as utilizing an analog input card of (or supported by) the external controller 555. Communication between the external controller 555 and the VFD 560 may be via Profibus and/or another communications protocol, and communication between the data historian 570 and each of the external controller 555 and the analog data logging device 565 may be via Ethernet and/or another communications protocol. The testing may include high speed logging, such as a sampling rate of at least 200 Hz. FIG. 5 is a plot of example raw VFD speed data logged by a 200 Hz data historian under a 2 Hz sine wave input, in which SpeedSp is depicted by the dotted line and SpeedPv is depicted by the solid line.

Returning to FIG. 2, the magnitude and phase delay for the different frequency sine inputs to the VFD-TD loop are determined (440) based on the logged data. The magnitude may be determined by finding the maximum (max) and minimum (min) over the time period of the input signals, and then determining the average value of the max and min values. The phase delay may be determined using discrete-time data sequences with delay estimate algorithms, such as a cross-correlation method. The raw data sequences may be pre-processed by removing the mean value. They may also be subjected to low-pass filtering.

After preprocessing, it is assumed that there are two equal-length, zero-mean, discrete time sequences x(n) and y(n) representing input and output. The sequence resulting from cross-correlation may then be as set forth below in Equation (8).

r_{xy}(l)=Σₙ₌₁^{N}x(n)y*(n+1), l=−(N−1),−(N−2), . . . , 0, 1, 2, . . . , (N−1) (8)

where y*(k)=y(k) as k=1 . . . N, otherwise y*(k)=0.

The resulting array r_{xy} has 2N−1 elements. The phase delay of each frequency is then determined, such as by determining the number of samples of y(n) that lag x(n) by finding the maximum of r_{xy} and then locating the index l*, such as via Equation (9) set forth below.

l*=argmax(r_{xy}), l=−(N−1), −(N−2), . . . , 0, 1, 2, . . . , (N−1) (9)

The determined (440) magnitude and phase responses are then compared (450) with the ideal values determined via the generated (410) model. Such comparison (450) may include assessing whether the determined (440) magnitude and phase responses are within close range of the model values to, in effect, determine if the determined (440) magnitude and phase responses satisfy the predetermined health-checking criteria.

For example, the health-checking criteria may include whether the determined (440) magnitude response is within +/−5% of the expected (420) values, and whether the determined (440) phase delay is within +/−5 milliseconds (ms) of the expected (420) values. These and/or other health-checking criteria may be predetermined and/or configurable through the associated GUI.

Delay times between the external controller inputs and outputs and between the VFD inputs and outputs are then assessed (460) using the logged data, such as by utilizing aspects similar to the magnitude and phase delay determination (440) and comparison (450) process described above. These delay times are considered as communication delay of the system, and the corresponding checking criteria may be that the delays are less than 50 ms and/or another predetermined threshold.

The method (400) may also include generating (470) a diagnosis report. Such report may include general rig and TD information, such as rig number, operator name, and the type, model, rated power, rated speed, and rated torque of the TD. The report may also include major VFD/control parameters, such as proportional and integral control gains of the ASR, the TD inertia, the filter time constant, etc. The report may also include one or more of (1) the predetermined and/or user-input health-checking criteria, (2) one or more figures depicting the modeled (420) and tested (450) magnitude and phase frequency responses, (3) a table or other display of the obtained (460) communication delays, (4) overall and/or test-specific pass/fail indications, and (5) reasons for the pass/fail indications.

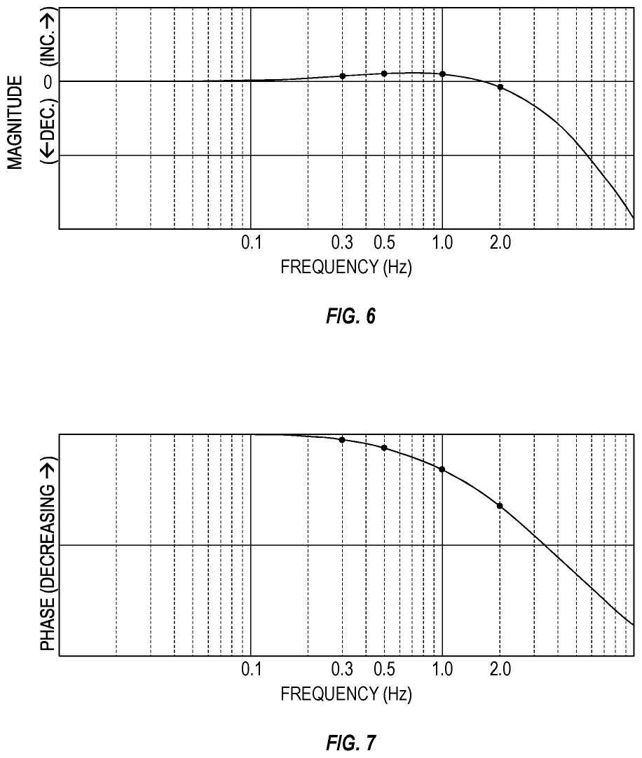

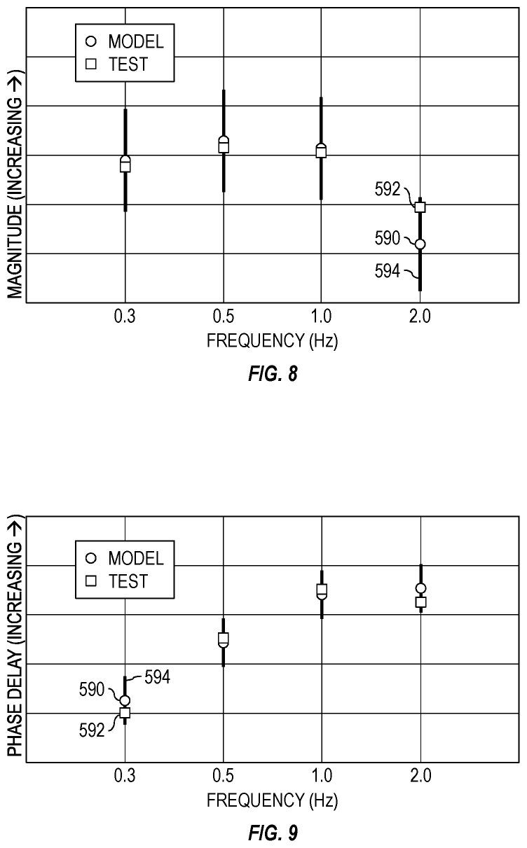

In an example application, 0.3 Hz, 0.5 Hz, 1.0 Hz, and 2.0 Hz sine waves with 5 rpm magnitude are applied to a TD with rated power at 800 horsepower (hp) and rated speed at 120 rpm. However, other implementations also within the scope of the present disclosure may perform the testing at different frequencies, a different number of frequencies (e.g., up to 10, 15, or 20 different frequencies), and/or a different magnitude (or even multiple magnitudes for multiple tests). The gearbox ratio is 10.5, the base low speed is 70 rpm, and the base high speed is 140 rpm. The system parameters are Kₚ=20,847 Nms/rad, Kᵢ=41,694 Nm/rad, T_{f}=0.004 s, and J=964 kg-m². The target frequency responses are depicted for magnitude in FIG. 6 and for phase in FIG. 7, with dots indicating the magnitude and phase responses at the input signal frequencies. With logged data of both high speed and low speed tests, the average magnitude and phase response of each input frequency is determined, as depicted for magnitude in FIG. 8 and for phase in FIG. 9.

The health-checking criteria for this example includes, for each checking point, whether the tested magnitude is within +/−5% of the modeled magnitude, and whether the tested phase delay time is within +/−5 ms of the modeled phase delay time. The overall “pass” criteria is that 80% of the checking points individually pass the health-checking criteria. For example, there are four test sine wave frequencies, and each are checked for magnitude and phase, so there are a total of eight points to consider for the overall pass criteria. Thus, the overall pass criteria is satisfied if at least seven of the eight test points individually pass the health-checking criteria. For example, in FIGS. 8 and 9, the dots 590 are the modeled values, the squares 592 are the test values, and the thick vertical lines 594 represent the health-checking criteria ranges. Because each of the test values 592 fall within the corresponding ranges 594, each of the eight points satisfy the overall pass criteria (i.e., 100%>80%).

For estimating the communication delay, the speed setpoint and feedback at the external controller were logged in a 1 ms manner while the speed setpoint and feedback of the ASR were logged by the data historian with a rate of 5 ms. The table set forth below lists the measured and estimated communication delay times for each test frequency. If a predetermined delay performance limit is set to above 30 ms, then each of the measured times satisfy the pass criteria.

| Tests | Average delay at | Average delay at | |
|---|---|---|---|
| (high/low | controller I/O | VFD by historian | Communication |
| speed) | (1 ms) | (5 ms) | delay NJ<−>VFD |
| 2.0 Hz | 72.5 ms | 42.5 ms | 29.0 ms |
| 1.0 Hz | 72.0 ms | 45.0 ms | 27.0 ms |
| 0.5 Hz | 59.5 ms | 35.0 ms | 24.5 ms |
| 0.3 Hz | 47.0 ms | 20.0 ms | 27.0 ms |

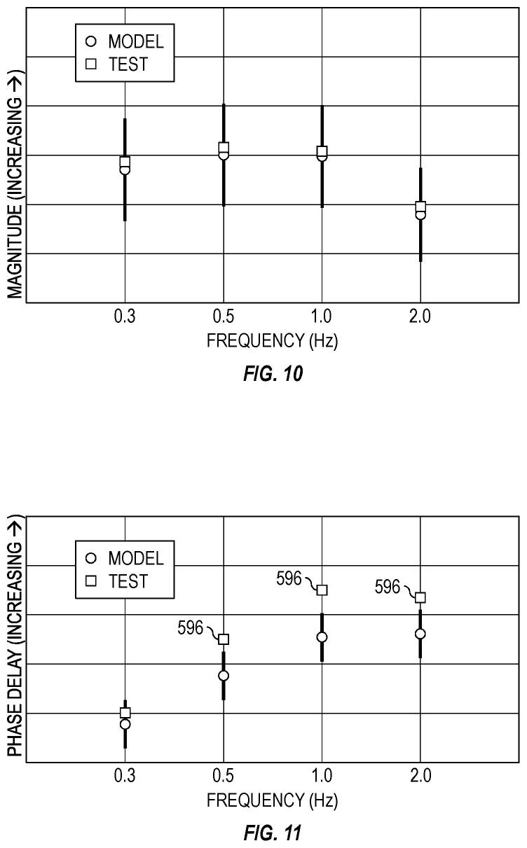

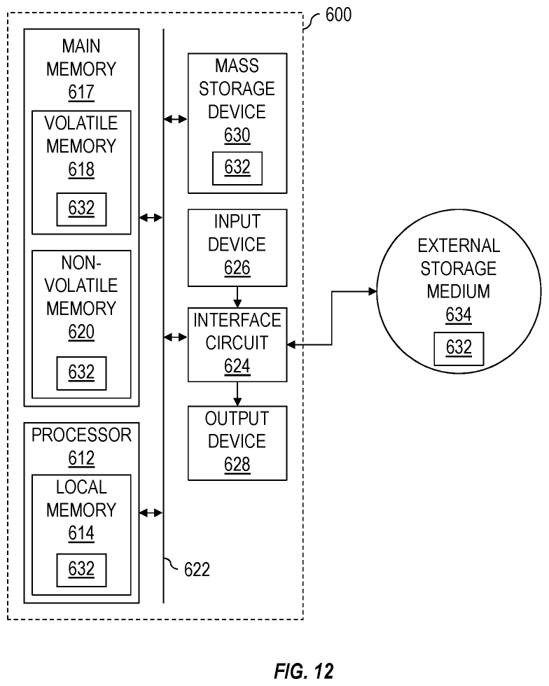

FIGS. 10 and 11 depict the results for another example, in which 80% of the TD inertia value is used in the reference model. Three of the measured phase delay times (indicated by reference numbers 596) are significantly longer than the expected values, and are out of the +/−5% criteria range. This indicates that the measured TD inertia may be inaccurate, perhaps due to utilizing too small (or simply wrong) of a value.

FIG. 12 is a schematic view of at least a portion of an example implementation of a processing device 600 according to one or more aspects of the present disclosure. Implementations of the processing device 600 may form at least a portion of one or more electronic devices described herein. For example, an implementation of the processing device 600 may be or form at least a portion of the controllers/processing devices 144, 192 shown in FIG. 1, as well as the external controller 555, the VFD 560, the analog data logging device 565, and/or the data historian 570 shown in FIG. 4.

The processing device 600 may be or comprise, for example, one or more processors, special-purpose computing devices, servers, personal computers (e.g., desktop, laptop, and/or tablet computers), personal digital assistants, smartphones, internet appliances, and/or other types of computing devices. The processing device 600 may comprise a processor 612, such as a general-purpose programmable processor. The processor 612 may comprise a local memory 614, and may execute coded instructions 632 present in the local memory 614 and/or another memory device. The processor 612 may execute the machine-readable coded instructions 632 and/or other instructions and/or programs to implement the example methods and/or operations described herein. The programs stored in the local memory 614 may include program instructions or computer program code that, when executed by the processor 612 of the processing device 600, may cause the apparatus described above to perform the example methods and/or operations described herein. The processor 612 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Other processors from other families may also be utilized.

The processor 612 may be in communication with a main memory 617, such as may include a volatile memory 618 and a non-volatile memory 620, perhaps via a bus 622 and/or other communication means. The volatile memory 618 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 620 may be, comprise, or be implemented by read-only memory, flash memory, and/or other types of memory devices. One or more memory controllers (not shown) may control access to the volatile memory 618 and/or non-volatile memory 620.

The processing device 600 may also comprise an interface circuit 624. The interface circuit 624 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 624 may also comprise a graphics driver card. The interface circuit 624 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

One or more input devices 626 may also be connected to the interface circuit 624. The input devices 626 may permit the human operators to enter the coded instructions 632, such as control commands, processing routines, operational set-points, and/or video display settings. The input devices 626 may be, comprise, or be implemented by a keyboard, a mouse, a joystick, a touchscreen, a track-pad, a trackball, an isopoint, and/or a voice recognition system, among other examples. One or more output devices 628 may also be connected to the interface circuit 624. The output devices 628 may be, comprise, or be implemented by video output devices (e.g., a liquid crystal display (LCD), a light-emitting diode (LED) display, and/or a touchscreen), printers, and/or speakers, among other examples. The processing device 600 may also communicate with one or more mass storage devices 630 and/or one or more removable storage mediums 634, such as may be or include compact disk (CD) drives, digital versatile disk (DVD) drives, and/or USB and/or other flash drives, among other examples.

The coded instructions 632 may be stored in the mass storage device 630, the main memory 617, the local memory 614, and/or the removable storage medium 634. Thus, the processing device 600 may be implemented in accordance with hardware (perhaps implemented in one or more chips including an integrated circuit, such as an ASIC), or may be implemented as software or firmware for execution by the processor 612. In the case of firmware or software, the implementation may be provided as a computer program product including a non-transitory, computer-readable medium or storage structure embodying computer program code (i.e., software or firmware) thereon for execution by the processor 612.

In view of the entirety of the present disclosure, including the figures and the claims, a person having ordinary skill in the art will readily recognize that the present disclosure introduces a method comprising: determining expected magnitude and phase frequency responses of a TD driven by a VFD, wherein the VFD and the TD are part of a VFD-TD system of a well drilling system, and wherein determining the expected magnitude and phase frequency responses utilizes a model of a control loop for the VFD and the TD; generating test data by injecting a sequence of sine wave signals with different, predetermined frequencies to the VFD as TD speed setpoint inputs on top of a constant base speed; determining magnitude and phase delay for the different frequency sine inputs to the VFD-TD control loop based on the test data; and assessing health of the VFD-TD system by comparing the determined magnitude and phase responses with the expected magnitude and phase responses.

The method may further comprise generating the model.

The model may utilize parameters involving control gains of an ASR associated with the VFD-TD combination, a delay time constant derived from a time constant of a low-pass filter delay time constant, and a measured inertia of the TD.

The method may further comprise inputting the parameters via a GUI.

The control loop may be modeled as comprising a PI controller and filter of the VFD, the TD inertia, an integrator, and a comparator that compares a speed setpoint with the output of the integrator, wherein the integrator output is the actual speed of the VFD or TD. The PI controller may generate a torque signal that is smoothed by the filter, wherein the smoothed torque signal results in accelerating the TD inertia, and subsequently TD speed is established by the integrator.

Generating the model may comprise utilizing transfer functions corresponding to the PI controller, the filter, the TD inertia, and the integrator, such as via the examples set forth above in Equations (1)-(4). The TD may utilize two or more AC motors together to provide rotational torque that rotates a drill string of the well drilling system. The VFD may drive the two or more AC motors. The VFD may comprise two or more VFDs that each drive a corresponding one of the two or more AC motors. For example, a master-slave scheme may be utilized for load/torque sharing, in which one of the two or more VFDs is a master drive, the other one or more VFDs are slave drives, and the master drive provides control signals to the slave drives. In such implementations, there may be a communication time delay for the control signals sent from the master drive to reach the one or more slave drives, and T_{f}=T_{f1}+T_{f2} may equal T_{f1}+T_{f2}, where T_{f1} is the time delay caused by the one or more digital and/or analog low-pass filters in the control loop, and T_{f2} is half of the communication time delay between the master and slave drives.

A time period of the signals at each frequency may be the same, and amplitude of the signals may constantly range from about five rpm to about twenty rpm at the TD.

The testing may include high speed logging at a sampling rate of at least 200 Hz.

Determining the magnitude may comprise: finding maximum and minimum values over the time period of the input signals; and determining averages of the maximum and minimum values.

Determining the phase delay may comprise using discrete-time data sequences with delay estimate algorithms.

Assessing the VFD-TD system health may comprise assessing whether the determined magnitude and phase responses are within a predetermined range of the expected magnitude and phase responses to determine if the determined magnitude and phase responses satisfy predetermined health-checking criteria. The health-checking criteria may include: whether the determined magnitude response is within +/−5% of the expected magnitude response; and whether the determined phase delay is within +/−5 milliseconds of the expected phase delay.

The method may further comprise assessing delay times between the external controller inputs and outputs using the test data. The method may further comprise assessing delay times between the VFD inputs and outputs using the test data.

The method may further comprise generating a diagnosis report based on the assessed health. The report may include general rig and/or TD information, including one or more of rig number, operator name, and the type, model, rated power, rated speed, and/or rated torque of the TD. The report may include VFD and/or other device control parameters, including one or more of proportional and integral control gains of an ASR associated with the VFD-TD combination, TD inertia, and one or more filter time constants. The report may include one or more predetermined and/or user-input health-checking criteria. The report may include one or more figures depicting the modeled and tested magnitude and phase frequency responses. The report may include a table or other display of the determined magnitude and phase delays. The report may include overall and/or test-specific pass/fail indications. The report may include reasons for the pass/fail indications. The method may further comprise displaying the diagnosis report on an electronic display.

The present disclosure also introduces a processing system comprising: a processor comprising a local memory; a main memory in communication with the processor; an input device in communication with the processor via an interface circuit; and an output device in communication with the processor via the interface circuit. The processor is operable to execute coded instructions stored in the memory device and/or the local memory to: (A) communicate with a VFD via the interface circuit, wherein the VFD is operable to drive a TD, and wherein the VFD and the TD are part of a VFD-TD system of a well drilling system; and (B) in response to human-initiation via the input device, automatically: (1) determine expected magnitude and phase frequency responses utilizing a model of a control loop for the VFD and the TD; (2) generate test data by injecting a sequence of sine wave signals with different, predetermined frequencies to the VFD as TD speed setpoint inputs on top of a constant base speed; (3) determine magnitude and phase delay for the different frequency sine inputs to the VFD-TD control loop based on the test data; and (4) output to the output device an indication of health of the VFD-TD system, wherein the health indication is based on a comparison of the determined magnitude and phase responses with the expected magnitude and phase responses.

The human-initiation via the input device may comprise neither information utilized to generate the model nor information utilized by the model.

The human-initiation via the input device may comprise a single interaction by the human with the input device. The interaction may be singly pressing a single button. The input device may be a touchscreen, and the interaction may be singly touching an icon displayed on the touchscreen.

The health indication output may comprise a diagnosis report. The report may include general rig and/or TD information, including one or more of rig number, operator name, and the type, model, rated power, rated speed, and/or rated torque of the TD. The report may include VFD and/or other device control parameters, including one or more of proportional and integral control gains of an ASR associated with the VFD-TD combination, TD inertia, and one or more filter time constants. The report may include one or more predetermined and/or user-input health-checking criteria. The report may include one or more figures depicting the modeled and tested magnitude and phase frequency responses. The report may include a table or other display of the determined magnitude and phase delays. The report may include overall and/or test-specific pass/fail indications. The report may include reasons for the pass/fail indications.

The present disclosure also introduces method comprising entering a single input to an input device of a processing system, thereby commencing operation of a processor of the processing system to execute coded instructions stored in memory of the processing system to: determine expected magnitude and phase frequency responses of a TD driven by a VFD, wherein the VFD and the TD are part of a VFD-TD system of a well drilling system, and wherein determining the expected magnitude and phase frequency responses utilizes a model of a control loop for the VFD and the TD; generate test data by injecting a sequence of sine wave signals with different, predetermined frequencies to the VFD as TD speed setpoint inputs on top of a constant base speed; determine magnitude and phase delay for the different frequency sine inputs to the VFD-TD control loop based on the test data; determine an indication of health of the VFD-TD system by comparing the determined and expected magnitude and phase responses; and output the health indication via an output device of the processing system.

The health indication output may comprise a diagnosis report. The report may include general rig and/or TD information, including one or more of rig number, operator name, and the type, model, rated power, rated speed, and/or rated torque of the TD. The report may include VFD and/or other device control parameters, including one or more of proportional and integral control gains of an ASR associated with the VFD-TD combination, TD inertia, and one or more filter time constants. The report may include one or more predetermined and/or user-input health-checking criteria. The report may include one or more figures depicting the modeled and tested magnitude and phase frequency responses. The report may include a table or other display of the determined magnitude and phase delays. The report may include overall and/or test-specific pass/fail indications. The report may include reasons for the pass/fail indications.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to permit the reader to quickly ascertain the nature of the technical disclosure. It is submitted with the understanding that it will not be used to interpret or limit the scope or meaning of the claims.

What is claimed is:

1. A method comprising:
determining expected magnitude and phase frequency responses of a top drive (TD) driven by a variable-frequency drive (VFD), wherein the VFD and the TD are part of a VFD-TD system of a well drilling system, and wherein determining the expected magnitude and phase frequency responses utilizes a model of a control loop for the VFD and the TD;
generating test data by injecting a sequence of sine wave signals with different, predetermined frequencies to the VFD as TD speed setpoint inputs on top of a constant base speed;
determining magnitude and phase delay for the different frequency sine inputs to the VFD-TD control loop based on the test data; and
assessing health of the VFD-TD system by comparing the determined magnitude and phase responses with the expected magnitude and phase responses.

2. The method of claim 1 wherein the model utilizes parameters involving control gains of an automatic speed regulator (ASR) associated with the VFD-TD combination, a delay time constant derived from a time constant of a low-pass filter delay time constant, and a measured inertia of the TD.

3. The method of claim 1 wherein the control loop is modeled as comprising a proportional-integral (PI) controller and filter of the VFD, the TD inertia, an integrator, and a comparator that compares a speed setpoint with the output of the integrator, and wherein the integrator output is the actual speed of the VFD or TD.

4. The method of claim 1 wherein generating the model comprises utilizing transfer functions corresponding to the PI controller, the filter, the TD inertia, and the integrator.

5. The method of claim 1 wherein:
a time period of the signals at each frequency is the same; and
amplitude of the signals constantly ranges from about five revolutions per minute (rpm) to about twenty rpm at the TD.

6. The method of claim 1 wherein the testing includes high speed logging at a sampling rate of at least 200 Hz.

7. The method of claim 1 wherein determining the magnitude comprises:
finding maximum and minimum values over the time period of the input signals; and
determining averages of the maximum and minimum values.

8. The method of claim 1 wherein determining the phase delay comprises using discrete-time data sequences with delay estimate algorithms.

9. The method of claim 1 wherein assessing the VFD-TD system health comprises assessing whether the determined magnitude and phase responses are within a predetermined range of the expected magnitude and phase responses to determine if the determined magnitude and phase responses satisfy predetermined health-checking criteria.

10. The method of claim 1 further comprising assessing delay times between the external controller inputs and outputs using the test data.

11. The method of claim 10 further comprising assessing delay times between the VFD inputs and outputs using the test data.

12. The method of claim 1 further comprising generating a diagnosis report comprising:
the assessed health; and
general rig and/or TD information, including one or more of rig number, operator name, and the type, model, rated power, rated speed, and/or rated torque of the TD.

13. The method of claim 1 further comprising generating a diagnosis report comprising:
the assessed health; and
VFD and/or other device control parameters, including one or more of proportional and integral control gains of an automatic speed regulator (ASR) associated with the VFD-TD combination, TD inertia, and one or more filter time constants.

14. The method of claim 1 further comprising generating a diagnosis report comprising:
the assessed health; and
one or more predetermined and/or user-input health-checking criteria.

15. The method of claim 1 further comprising generating a diagnosis report comprising:
the assessed health; and
overall and/or test-specific pass/fail indications.

16. A processing system comprising:
a processor comprising a local memory;
a main memory in communication with the processor;
an input device in communication with the processor via an interface circuit; and
an output device in communication with the processor via the interface circuit;
wherein the processor is operable to execute coded instructions stored in the memory device and/or the local memory to:
communicate with a variable-frequency drive (VFD) via the interface circuit, wherein the VFD is operable to drive a top drive (TD), and wherein the VFD and the TD are part of a VFD-TD system of a well drilling system; and
in response to human-initiation via the input device, automatically:
determine expected magnitude and phase frequency responses utilizing a model of a control loop for the VFD and the TD;
generate test data by injecting a sequence of sine wave signals with different, predetermined frequencies to the VFD as TD speed setpoint inputs on top of a constant base speed;
determine magnitude and phase delay for the different frequency sine inputs to the VFD-TD control loop based on the test data; and
output to the output device an indication of health of the VFD-TD system, wherein the health indication is based on a comparison of the determined magnitude and phase responses with the expected magnitude and phase responses.

17. The processing system of claim 16 wherein the human-initiation via the input device comprises neither information utilized to generate the model nor information utilized by the model.

18. The processing system of claim 16 wherein the human-initiation via the input device comprises a single interaction by the human with the input device.

19. A method comprising:
entering a single input to an input device of a processing system, thereby commencing operation of a processor of the processing system to execute coded instructions stored in memory of the processing system to:
determine expected magnitude and phase frequency responses of a top drive (TD) driven by a variable-frequency drive (VFD), wherein the VFD and the TD are part of a VFD-TD system of a well drilling system, and wherein determining the expected magnitude and phase frequency responses utilizes a model of a control loop for the VFD and the TD;
generate test data by injecting a sequence of sine wave signals with different, predetermined frequencies to the VFD as TD speed setpoint inputs on top of a constant base speed;
determine magnitude and phase delay for the different frequency sine inputs to the VFD-TD control loop based on the test data;
determine an indication of health of the VFD-TD system by comparing the determined and expected magnitude and phase responses; and
output the health indication via an output device of the processing system.

20. The method of claim 19 wherein the health indication output comprises a diagnosis report comprising:
general rig and/or TD information, including one or more of rig number, operator name, and the type, model, rated power, rated speed, and/or rated torque of the TD;
VFD and/or other device control parameters, including one or more of proportional and integral control gains of an automatic speed regulator (ASR) associated with the VFD-TD combination, TD inertia, and one or more filter time constants;
one or more predetermined and/or user-input health-checking criteria;
overall and/or test-specific pass/fail indications; and
reasons for the pass/fail indications.
